(19) United States
(12) Patent Application Publication
(10) Pub. No.: US 2006/0132549 A1
(43) Pub. Date: Jun. 22, 2006

(54) Method for producing actuator device, and liquid-jet apparatus

(75) Inventor: Maki Ito, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/295,608

(22) Filed: Dec. 7, 2005

(30) Foreign Application Priority Data
Dec. 20, 2004 (JP) 2004-368221

(51) Int. Cl. B41J 2/045

(52) U.S. Cl. 347/70

(57) ABSTRACT

A method for producing an actuator device, comprising the steps of: forming a vibration plate on one surface of a substrate; and forming piezoelectric elements, each of which composes a lower electrode, a piezoelectric layer, and an upper electrode, on the vibration plate, and wherein the step of forming the vibration plate has an insulation film formation step including at least a film forming step of forming a zirconium layer on the one surface of the substrate, and a thermal oxidation step of thermally oxidizing the zirconium layer at a predetermined thermal oxidation temperature to form an insulation film comprising a zirconium oxide layer and, simultaneously, adjusting a stress of the insulation film.

### BACKGROUND OF THE INVENTION

1. Field of the Invention

This invention relates to a method for producing an actuator device, which comprises constructing a part of a pressure generating chamber from a vibration plate, forming a piezoelectric element having a piezoelectric layer on the vibration plate, and deforming the vibration plate by displacement of the piezoelectric element; and a liquid-jet apparatus for ejecting liquid droplets by use of the actuator device.

2. Description of the Related Art

An actuator device comprising a piezoelectric element, which is displaced by application of a voltage, is used, for example, as a liquid ejection means of a liquid-jet head installed in a liquid-jet apparatus for jetting liquid droplets. Known as such a liquid-jet apparatus is, for example, an ink-jet recording apparatus having an ink-jet recording head in which a part of a pressure generating chamber communicating with a nozzle orifice is composed of a vibration plate, and the vibration plate is deformed by a piezoelectric element to pressurize ink in the pressure generating chamber, thereby ejecting ink droplets from the nozzle orifice.

Two types of ink-jet recording heads are put into practical use. One of them is mounted with an actuator device of longitudinal vibration mode which expands and contracts in the axial direction of the piezoelectric element. The other is mounted with an actuator device of flexural vibration mode. The ink-jet recording head using the actuator device of flexural vibration mode includes, for example, that produced by forming a uniform piezoelectric layer on the entire surface of a vibration plate by a film forming technology, and cutting this piezoelectric layer into shapes corresponding to pressure generating chambers by lithography to form piezoelectric elements independently for the respective pressure generating chambers.

Lead zirconate titanate (PZT), for example, is used as a material for the piezoelectric material layer constituting the piezoelectric element. In this case, when the piezoelectric material layer is fired, the lead component of the piezoelectric material layer is diffused into a silicon oxide (SiO₂) film which is provided on the face of a passage-forming substrate comprising silicon (Si) to constitute the vibration plate. The diffusion of the lead component poses the problem that the melting point of silicon oxide lowers, and the silicon oxide film melts with heat generated during the firing of the piezoelectric material layer. To solve this problem, a structure is contemplated, for example, in which a zirconium oxide film constituting a vibration plate and having a predetermined thickness is provided on a silicon oxide film, and a piezoelectric material layer is provided on the zirconium oxide film, thereby preventing diffusion of the lead component from the piezoelectric material layer into the silicon oxide film (see, for example, Japanese Patent Application Laid-Open No. 1999-204849).

The zirconium oxide film is formed, for example, by forming a zirconium film by the sputtering method, and thermally oxidizing the zirconium film. This presents the problem of a detect, such as cracks caused to the zirconium oxide film by stress occurring during the thermal oxidation of the zirconium film. If there is a great difference in stress between the passage-forming substrate and the zirconium oxide film, moreover, a problem occurs, for example, such that after the formation of the pressure generating chamber in the passage-forming substrate, the passage-forming substrate, etc. deform, whereupon the zirconium film peels off.

### SUMMARY OF THE INVENTION

The present invention has been accomplished in the light of the above-described circumstances. It is an object of the invention to provide a method for producing an actuator device improved in durability and reliability while preventing a defect, such as cracking of a vibration plate; and a liquid-jet apparatus.

A first aspect of the present invention for attaining the above object is a method for producing an actuator device, comprising the steps of: forming a vibration plate on one surface of a substrate; and forming piezoelectric elements, each of which composes a lower electrode, a piezoelectric layer, and an upper electrode, on the vibration plate, and wherein the step of forming the vibration plate has an insulation film formation step including at least a film forming step of forming a zirconium layer on the one surface of the substrate, and a thermal oxidation step of thermally oxidizing the zirconium layer at a predetermined thermal oxidation temperature to form an insulation film comprising a zirconium oxide layer and, simultaneously, adjusting a stress of the insulation film.

In the first aspect, when the insulation film is formed, its stress is adjusted. Thus, the vibration plate can be formed without causing cracking, etc. Moreover, all films including the piezoelectric element can be brought into a satisfactory stress state, and an actuation device rendered uniform in the displacement characteristics of the piezoelectric element can be produced.

A second aspect of the present invention is the method for producing an actuator device according to the first aspect, characterized in that in the thermal oxidation step, the stress of the insulation film is adjusted by controlling the thermal oxidation temperature.

In the second aspect, the stress of the insulation film can be adjusted more reliably.

A third aspect of the present invention is the method for producing an actuator device according to the first or second aspect, characterized in that in the thermal oxidation step, the zirconium layer is thermally oxidized by a diffusion furnace.

In the third aspect, the stress of the insulation film can be adjusted further reliably.

A fourth aspect of the present invention is the method for producing an actuator device according to any one of the first to third aspects, characterized in that the temperature during thermal oxidation of the zirconium layer is 800° C. or above, but 1,000° C. or below.

In the fourth aspect, the zirconium layer can be thermally oxidized satisfactorily, and the stress of the insulation film can be adjusted more reliably.

A fifth aspect of the present invention is the method for producing an actuator device according to any one of the first to fourth aspects, characterized in that the insulation film formation step further includes an annealing step which is performed after the thermal oxidation step to anneal the insulation film at a temperature not higher than the thermal oxidation temperature, thereby adjusting the stress of the insulation film further.

In the fifth aspect, the adhesion of the insulation film constituting the vibration plate can be increased. Also, variations in the adhesion of the insulation film in the same wafer can be decreased.

A sixth aspect of the present invention is an actuator device produced by the method of any one of the first to fifth aspects.

In the sixth aspect, an actuator device improved in the durability of the vibration plate and rendered uniform in the displacement characteristics of the piezoelectric element can be achieved.

A seventh aspect of the present invention is a liquid-jet apparatus comprising a liquid-jet head having as a liquid ejection means the actuator device produced by the method of any one of the first to fifth aspects.

In the seventh aspect, a liquid-jet apparatus, which can be improved in the durability of the vibration plate, which can be increased in the amount of displacement of the vibration plate by driving of the piezoelectric element, and whose ejection characteristics for liquid droplets are enhanced, can be achieved.

### BRIEF DESCRIPTION OF THE DRAWINGS

For a more complete understanding of the present invention and the advantages thereof, reference is now made to the following descriptions in conjunction with the accompanying drawings.

FIG. 1 is an exploded perspective view of a recording head according to Embodiment 1.

FIGS. 2A and 2B are a plan view and a sectional view, respectively, of the recording head according to Embodiment 1.

FIGS. 3A to 3D are sectional views showing steps in a manufacturing process for the recording head according to Embodiment 1.

FIGS. 4A to 4D are sectional views showing the steps in the manufacturing process for the recording head according to Embodiment 1.

FIGS. 5A and 5B are sectional views showing the steps in the manufacturing process for the recording head according to Embodiment 1.

FIG. 6 is a schematic view of a diffusion furnace used in the manufacturing process.

FIG. 7 is a graph showing the stresses of insulation films after thermal oxidation treatments.

FIG. 8 is a graph showing changes in the stress of the insulation film after annealing compared with the stress before annealing.

FIG. 9 is a schematic view of a recording apparatus according to an embodiment of the present invention.

### DESCRIPTION OF THE PREFERRED EMBODIMENTS

The present invention will now be described in detail based on the embodiments offered below.

### Embodiment 1

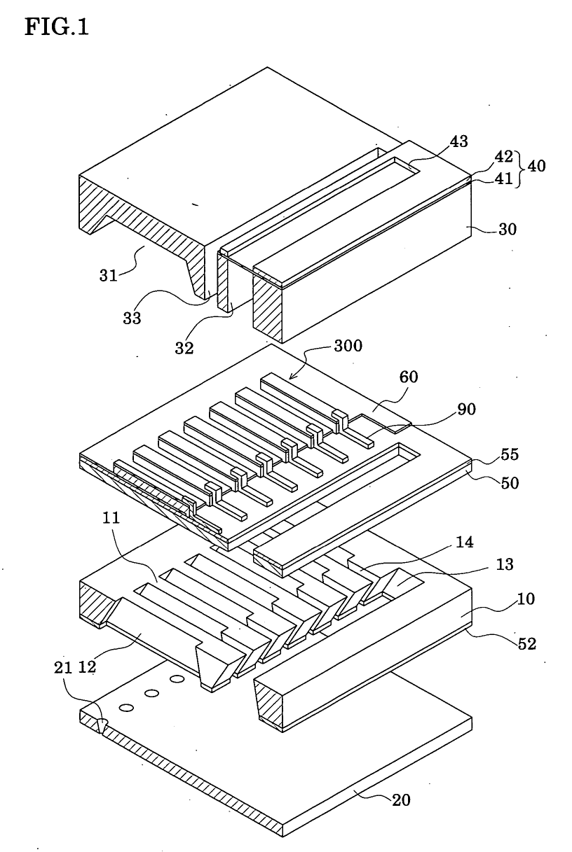

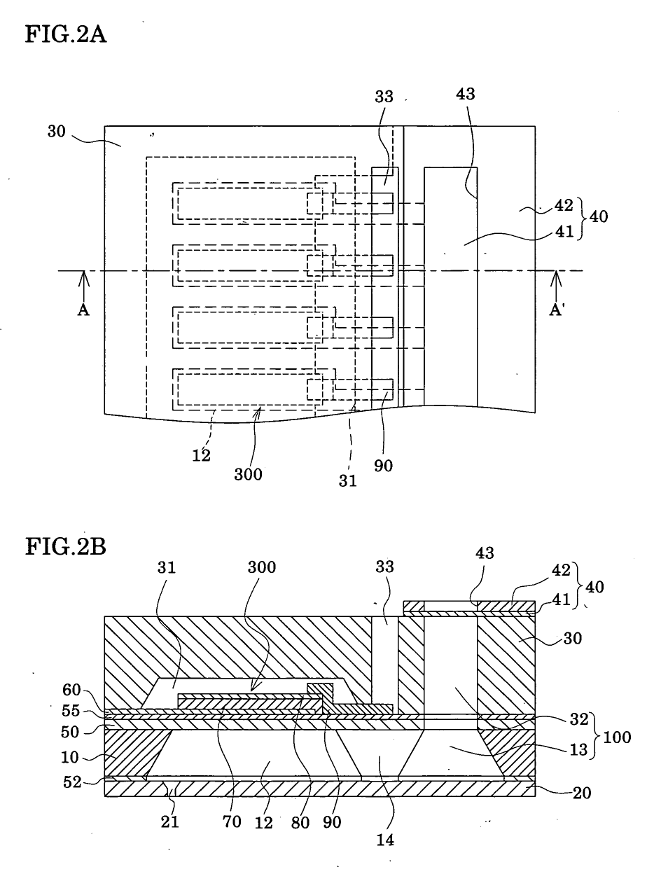

FIG. 1 is an exploded perspective view showing an ink-jet recording head according to Embodiment 1 of the present invention. FIG. 2A and FIG. 2B are a plan view and a sectional view, respectively, of the ink-jet recording head in FIG. 1. As shown in these drawings, a passage-forming substrate 10, in the present embodiment, consists of a single crystal silicon substrate having a plane (110) of the plane orientation. An elastic film 50 comprising silicon dioxide and having a thickness of 0.5 to 2 μm, formed beforehand by thermal oxidation, is present on one surface of the passage-forming substrate 10. In the passage-forming substrate 10, a plurality of pressure generating chambers 12 are disposed parallel in the width direction of the passage-forming substrate 10. A communicating portion 13 is formed in a region longitudinally outward of the pressure generating chambers 12 in the passage-forming substrate 10. The communicating portion 13 and each of the pressure generating chambers 12 are brought into communication via an ink supply path 14 provided for each of the pressure generating chambers 12. The communicating portion 13 communicates with a reservoir portion of a protective plate (to be described later) to constitute a reservoir serving as a common ink chamber for the respective pressure generating chambers 12. The ink supply path 14 is formed in a narrower width than that of the pressure generating chamber 12, and keeps constant the passage resistance of ink flowing from the communicating portion 13 into the pressure generating chamber 12.

Onto an opening surface of the passage-forming substrate 10, a nozzle plate 20 having nozzle orifices 21 bored therein is secured by an adhesive agent or a heat sealing film. Each of the nozzle orifices 21 communicates with the neighborhood of the end of the pressure generating chamber 12 on the side opposite to the ink supply path 14. The nozzle plate 20 comprises a glass ceramic having a thickness of, for example, 0.01 to 1 mm, and a linear expansion coefficient of, for example, 2.5 to 4.5[×10⁻⁶/° C.] at 300° C. or below, a single crystal silicon substrate, or stainless steel.

On the surface of the passage-forming substrate 10 opposite to the opening surface, the elastic film 50 having a thickness, for example, of about 1.0 μm and comprising silicon dioxide (SiO₂) is formed, as described above. An insulation film 55 having a thickness, for example, of about 0.3 μm and comprising zirconium oxide (ZrO₂) is formed on the elastic film 50. On the insulation film 55, a lower electrode film 60 with a thickness, for example, of about 0.2 μm, a piezoelectric layer 70 with a thickness, for example, of about 1.0 μm, and an upper electrode film 80 with a thickness, for example, of about 0.05 μm are formed in a laminated state by a process (to be described later) to constitute a piezoelectric element 300. The piezoelectric element 300 refers to a portion including the lower electrode film 60, the piezoelectric layer 70, and the upper electrode film 80. Generally, one of the electrodes of the piezoelectric element 300 is used as a common electrode, and the other electrode and the piezoelectric layer 70 are constructed for each pressure generating chamber 12 by patterning. A portion, which is composed of any one of the electrodes and the piezoelectric layer 70 that have been patterned, and which undergoes piezoelectric distortion upon application of voltage to both electrodes, is called a piezoelectric active portion. In the present embodiment, the lower electrode film 60 is used as the common electrode for the piezoelectric elements 300, while the upper electrode film 80 is used as an individual electrode of each piezoelectric element 300. However, there is no harm in reversing their usages for the convenience of a drive circuit or wiring. In either case, it follows that the piezoelectric active portion is formed for each pressure generating chamber. Herein, the piezoelectric elements 300 and a vibration plate, where displacement is caused by drive of the piezoelectric elements 300, are referred to collectively as a piezoelectric actuator. A lead electrode 90 comprising, for example, gold (Au) is connected to the upper electrode film 80 of each piezoelectric element 300. Voltage is selectively applied to each piezoelectric element 300 via the lead electrode 90.

To a surface on the passage-forming substrate 10 where the piezoelectric elements 300 are located, a protective plate 30 having a piezoelectric element holding portion 31, which can ensure a space wide enough not to impede the movement of the piezoelectric elements 300, is bonded in a region opposed to the piezoelectric elements 300. Since the piezoelectric elements 300 are formed within the piezoelectric element holding portion 31, they are protected in a state in which they are substantially free from the influence of an external environment. In the protective plate 30, moreover, a reservoir portion 32 is provided in a region corresponding to the communicating portion 13 of the passage-forming substrate 10. The reservoir portion 32, in the present embodiment, is provided along the direction of parallel arrangement of the pressure generating chambers 12 so as to penetrate the protective plate 30 in its thickness direction. As mentioned above, the reservoir portion 32 is brought into communication with the communicating portion 13 of the passage-forming substrate 10 to constitute a reservoir 100 which serves as a common ink chamber for the respective pressure generating chambers 12.

In a region of the protective plate 30 defined between the piezoelectric element holding portion 31 and the reservoir portion 32, a through-hole 33 is provided which penetrates the protective plate 30 in its thickness direction. A portion of the lower electrode film 60 and a front end portion of the lead electrode 90 are exposed in the through-hole 33. One end of connecting wiring extending from a drive IC is connected to the lower electrode film 60 and the lead electrode 90, although this is not shown.

The material for the protective plate 30 is, for example, glass, a ceramic material, a metal, or a resin. Preferably, the protective plate 30 is formed of a material having nearly the same thermal expansion coefficient as that of the passage-forming substrate 10. In the present embodiment, the protective plate 30 is formed from a single crystal silicon substrate which is the same material as that for the passage-forming substrate 10.

Furthermore, a compliance plate 40, which consists of a sealing film 41 and a fixing plate 42, is bonded onto the protective plate 30. The sealing film 41 comprises a low rigidity, flexible material (for example, a polyphenylene sulfide (PPS) film of 6 μm in thickness), and the sealing film 41 seals one surface of the reservoir portion 32. The fixing plate 42 is formed from a hard material such as a metal (for example, stainless steel (SUS) of 30 μm in thickness). A region of the fixing plate 42 opposite the reservoir 100 defines an opening portion 43 completely deprived of the plate in the thickness direction. Thus, one surface of the reservoir 100 is sealed only with the sealing film 41 having flexibility.

With the ink-jet recording head of the present embodiment described above, ink is taken in from external ink supply means (not shown), and the interior of the head ranging from the reservoir 100 to the nozzle orifices 21 is filled with the ink. Then, according to recording signals from the drive IC (not shown), voltage is applied between the lower electrode film 60 and the upper electrode film 80 corresponding to the pressure generating chamber 12 to flexibly deform the elastic film 50, the insulation film 55, the lower electrode film 60 and the piezoelectric layer 70. As a result, the pressure inside the pressure generating chamber 12 rises to eject ink droplets through the nozzle orifice 21.

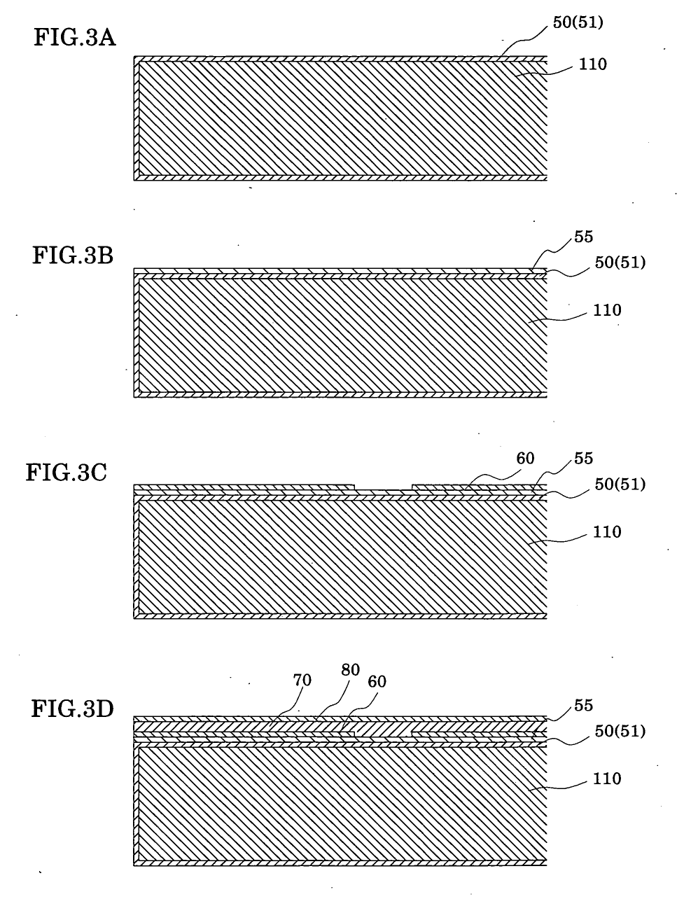

The method for producing the above-mentioned ink-jet recording head will be described with reference to FIGS. 3A to 3D through FIGS. 5A and 5B. These drawings are sectional views in the longitudinal direction of the pressure generating chamber 12. Firstly, as shown in FIG. 3A, a passage-forming substrate wafer 110, which is a silicon wafer, is thermally oxidized in a diffusion furnace at about 1,100° C. to form a silicon dioxide film 51 constituting the elastic film 50 on the surface of the wafer 110. In the present embodiment, a silicon wafer having a relatively large thickness of about 625 μm and having high rigidity is used as the passage-forming substrate wafer 110.

Then, as shown in FIG. 3B, the insulation film 55 comprising zirconium oxide is formed on the elastic film 50 (silicon dioxide film 51). Concretely, a zirconium layer having a predetermined thickness, about 0.3 μm in the present embodiment, is formed on the elastic film 50, for example, by DC sputtering. Then, the passage-forming substrate wafer 110 having the zirconium layer formed thereon is heated, for example, in a diffusion furnace to thermally oxidize the zirconium layer, thereby forming the insulation film 55 comprising zirconium oxide.

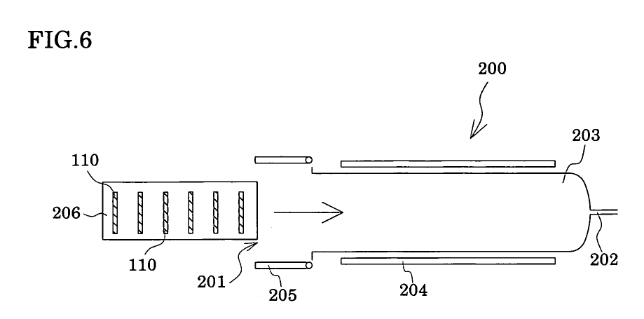

A diffusion furnace 200 used for the thermal oxidation of the zirconium layer, as shown, for example, in FIG. 6, is composed of a core tube 203 having an entrance 201 at one end and an inlet 202 for a reactant gas at the other end, and a heater 204 disposed outside the core tube 203. The entrance 201 can be opened and closed with a shutter 205. In the present embodiment, a plurality of the passage-forming substrate wafers 110 each having the zirconium layer formed thereon are fixed to a boat 206 as a fixing jig. The boat 206 is inserted at a rate of, for example, 200 mm/minor higher into the diffusion furnace 200 heated to a predetermined temperature. Then, with the shutter 205 being closed, the wafers 110 are held for about 1 hour to thermally oxidize the zirconium layer, forming the insulation film 55.

In the present invention, moreover, the stress of the insulation film 55 is adjusted by controlling the thermal oxidation temperature during formation of the insulation film 55 by thermal oxidation of the zirconium layer, for example, the temperature of the diffusion furnace in the present embodiment. In the present embodiment, for example, the zirconium layer is thermally oxidized in the diffusion furnace heated to about 900° C. By so adjusting the stress of the insulation film 55, the stress balance of all films, including the respective layers constituting the piezoelectric element after formation of the piezoelectric element, is rendered satisfactory, and peeling of the respective films or the occurrence of cracks due to stress can be prevented. Zirconium oxide (ZrO₂) constituting the insulation film 55, in particular, has a relatively high Young's modulus in comparison with other materials such as silicon oxide (SiO₂) constituting the elastic film 50, so that the stress of zirconium oxide can be adjusted in a relatively wide range. By adjusting the stress of such insulation film 55, therefore, the stress balance of all films can be rendered satisfactory more reliably.

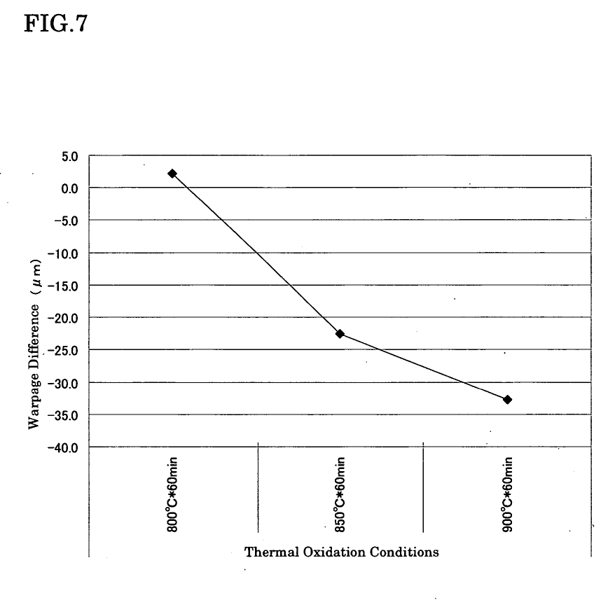

The results of the investigation of changes in the stress of the insulation film according to differences in the thermal oxidation conditions will be explained. A plurality of the passage-forming substrate wafers each having the zirconium layer formed under certain conditions on the elastic film comprising silicon dioxide were inserted into the diffusion furnace heated to about 800° C., 850° C. and 900° C., and thermally oxidized for about 60 minutes to form the insulation films. Each of the resulting insulation films was examined for the amount of warpage (warpage difference from the amount of warpage of the elastic film). The results are shown in FIG. 7. The amount of warpage herein refers to the amount of warpage of the insulation film over a span of about 140 mm at a central portion of the passage-forming substrate wafer. As shown in FIG. 7, the amount of warpage of the insulation film changed in accordance with the temperature during thermal oxidation of the zirconium layer (temperature of the diffusion furnace). As clear from these results, the insulation film can be adjusted to a preferred stress state by controlling the temperature during thermal oxidation of the zirconium layer. Of course, the stress of the insulation film can be adjusted by controlling the duration of thermal oxidation, as well as the temperature of thermal oxidation.

In the present embodiment, the zirconium layer is thermally oxidized by the diffusion furnace. However, this is not limitative, and the zirconium layer may be thermally oxidized, for example, using RTA (rapid thermal annealing).

In the present embodiment, when the insulation film 55 is formed, namely, when the zirconium layer is thermally oxidized, the stress of the insulation film 55 is adjusted. However, it is permissible to thermally oxidize the zirconium layer to form the insulation film 55, and then further anneal the insulation film 55 at a predetermined temperature, thereby further adjusting the stress of the insulation film 55.

Concretely, the insulation film 55 may be annealed at a temperature not higher than the maximum temperature during thermal oxidation of the above zirconium layer, at a temperature of 900° C. or lower in the present embodiment, and the conditions for the annealing, such as temperature and time, may be changed to adjust the stress of the insulation film 55 further.

By so annealing the insulation film 55 to adjust its stress, it is possible to achieve a better stress balance of all films including the respective layers constituting the piezoelectric element to be formed by steps (to be described later), thereby reliably preventing peeling or cracking of films due to stress. Moreover, the heating temperature during annealing is rendered not higher than the maximum temperature during thermal oxidation of the zirconium layer, whereby the adhesion of the insulation film 55 can be maintained. Another effect obtained is that variations in the adhesion of the insulation film in the planar direction of the passage-forming substrate wafer can be decreased.

The heating temperature during annealing is not limited, if it is the above maximum temperature or below, but it is preferably as high a temperature as possible. The reason is that the stress of the insulation film, as stated above, is determined by the conditions during annealing, such as heating temperature and heating time, and a higher heating temperature can complete the adjustment of stress (annealing) in a relatively short time, thus increasing the manufacturing efficiency.

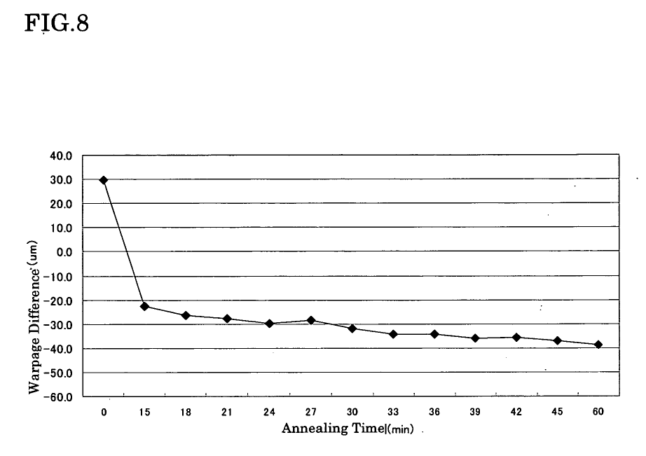

Changes in the stress of the insulation film after annealing compared with that before annealing were investigated, and the results will be described. The insulation film formed by thermal oxidation of the zirconium layer formed on the elastic film was annealed under the conditions: a heating temperature of 900° C. and a heating time of 60 min. The amount of warpage (warpage difference) of the insulation film was examined after the lapse of predetermined times. The results are shown in FIG. 8. The amount of warpage herein refers to the amount of warpage of the insulation film over a span of about 140 mm at a central portion of the passage-forming substrate wafer. As shown in FIG. 8, the maximum amount of warpage of the insulation film before annealing was about ±30 μm. That is, the insulation film before annealing underwent warpage such that the elastic film was concave. The amount of warpage of the insulation film markedly changed until about 15 minutes after start of annealing but, afterwards, continued to change gradually in the negative-value direction. The insulation film after 60 minutes of annealing had warpage such that its maximum warpage amount was about −40 μm, meaning that the elastic film became convex. As these results demonstrate, the stress of the insulation film 55 changes upon annealing as well. Thus, after the zirconium layer is thermally oxidized to form the insulation film, the insulation film is annealed, whereby the insulation film 55 can be adjusted to a more preferred stress state. Of course, the stress of the insulation film can be adjusted by controlling the temperature, as well as the annealing time.

After the insulation film 55 is formed, platinum and iridium, for example, are stacked on the insulation film 55 to form the lower electrode film 60, whereafter the lower electrode film 60 is patterned into a predetermined shape, as shown in FIG. 3C. Then, as shown in FIG. 3D, the piezoelectric layer 70 comprising, for example, lead zirconate titanate (PZT), and the upper electrode film 80 comprising, for example, iridium, are formed on the entire surface of the passage-forming substrate wafer 110. In the present embodiment, the piezoelectric layer 70 comprising lead zirconate titanate (PZT) is formed by the so-called sol-gel process which comprises dissolving or dispersing metal organic materials in a catalyst to form a sol, coating and drying the sol to form a gel, and firing the gel at a high temperature to obtain the piezoelectric layer 70 comprising the metal oxide.

The material for the piezoelectric layer 70 may be, for example, a ferroelectric piezoelectric material such as lead zirconate titanate (PZT), or a relax or ferroelectric having a metal, such as niobium, nickel, magnesium, bismuth or yttrium, added to such a ferroelectric piezoelectric material. The composition of the piezoelectric layer 70 may be chosen, as appropriate, in consideration of the characteristics, uses, etc. of the piezoelectric element. Its examples are PbTiO₃ (PT), PbZrO₃ (PZ), Pb(ZrₓTi₁₋ₓ)O₃ (PZT), Pb(Mg_{1/3}Nb_{2/3})O₃—PbTiO₃ (PMN-PT), Pb (Zn_{1/3}Nb_{2/3})O₃—PbTiO₃ (PZN-PT), Pb (Ni_{1/3}Nb_{2/3})O₃—PbTiO₃ (PNN-PT), Pb(In_{1/2}Nb_{1/2})O₃—PbTiO₃ (PIN-PT), Pb(Sc_{1/3}Ta_{2/3})O₃—PbTiO₃ (PST-PT), Pb (Sc_{1/3}Nb_{2/3})O₃—PbTiO₃ (PSN-PT), BiScO₃—PbTiO₃ (BS-PT), and BiYbO₃—PbTiO₃ (BY-PT). The method for forming the piezoelectric layer 70 is not limited to the sol-gel process. For example, MOD (metal-organic decomposition) may be used.

As stated earlier, in the present invention, the stress of the insulation film 55 is adjusted when at least the zirconium layer is thermally oxidized. Instead, when the piezoelectric layer 70 is formed, for example, the conditions such as the firing temperature may be changed, whereby the stress of the insulation film 55 can be adjusted. However, this is not preferred, because if the conditions such as the firing temperature of the piezoelectric layer 70 are changed, the physical properties of the piezoelectric layer 70 change, and it is likely that the desired characteristics will not be obtained.

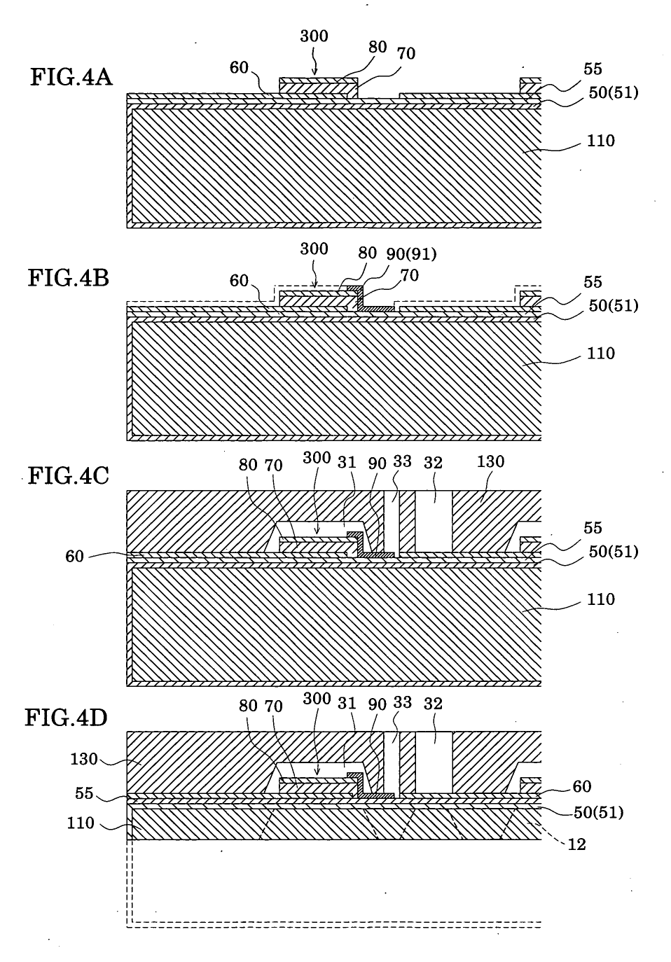

Then, as shown in FIG. 4A, the piezoelectric layer 70 and the upper electrode film 80 are patterned in a region opposite the respective pressure generating chambers 12 to form the piezoelectric elements 300. Then, the lead electrodes 90 are formed. Concretely, as shown in FIG. 4B, a metal layer 91 comprising, for example, gold (Au) is formed on the entire surface of the passage-forming substrate wafer 110. Then, the metal layer 91 is patterned for the respective piezoelectric elements 300 via a mask pattern (not shown) comprising, for example, a resist to form the lead electrodes 90.

Then, as shown in FIG. 4C, a protective plate wafer 130, which is a silicon wafer and is to become a plurality of protective plates 30, is bonded onto a surface of the passage-forming substrate wafer 110 where the piezoelectric elements 300 have been formed. The protective plate wafer 130 has a thickness, for example, of the order of 400 μm, and thus the rigidity of the passage-forming substrate wafer 110 is markedly increased by bonding the protective plate wafer 130 thereto.

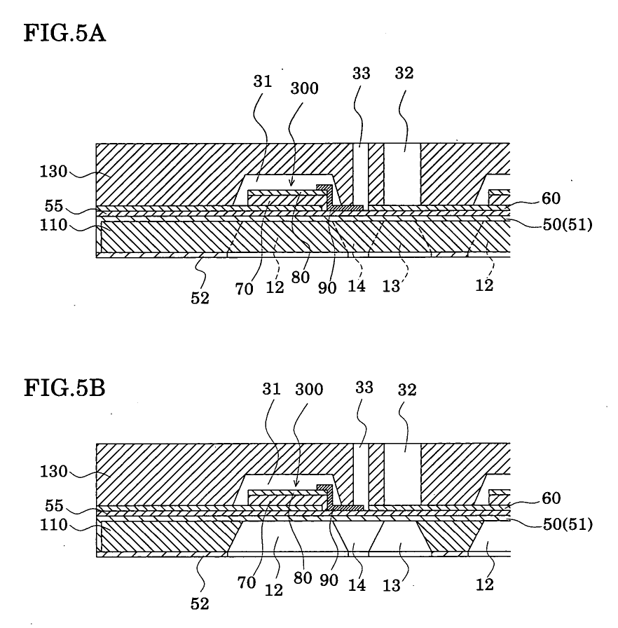

Then, as shown in FIG. 4D, the passage-forming substrate wafer 110 is polished to a certain thickness, and then is wet-etched with fluoronitric acid to bring the passage-forming substrate wafer 110 into a predetermined thickness. In the present embodiment, for example, the passage-forming substrate wafer 110 is etched to have a thickness of about 70 μm. Then, as shown in FIG. 5A, the mask film 52 comprising, for example, silicon nitride (SiN) is formed anew on the passage-forming substrate wafer 110, and is patterned into a predetermined shape. Then, as shown in FIG. 5B, the passage-forming substrate wafer 110 is subjected to anisotropic etching via the mask film 52 to form the pressure generating chambers 12, the communicating portion 13 and the ink supply paths 14 in the passage-forming substrate wafer 110.

Then, unnecessary regions of the outer peripheral edge portions of the passage-forming substrate wafer 110 and the protective plate wafer 130 are removed, for example, by cutting by means of dicing. Then, the nozzle plate 20 having the nozzle orifices 21 bored therein is bonded to the surface of the passage-forming substrate wafer 110 opposite to the protective plate wafer 130, and the compliance plate 40 is bonded to the protective plate wafer 130. The passage-forming substrate wafer 110 including the other members is divided into the passage-forming substrate 10, etc. of one-chip size as shown in FIG. 1 to produce the ink-jet recording head of the present embodiment.

In the present invention, as described above, when the insulation film 55 comprising zirconium oxide is formed on the elastic film 50, the zirconium layer is thermally oxidized, and then annealed under predetermined conditions. By this procedure, the adhesion of the insulation film 55 can be increased and the stress of the insulation film 55 can be adjusted. Thus, the ink-jet recording head can be achieved which is improved in the durability of the vibration plate, which can be increased in the amount of displacement of the vibration plate by driving of the piezoelectric element 300, and whose ink ejection characteristics are enhanced.

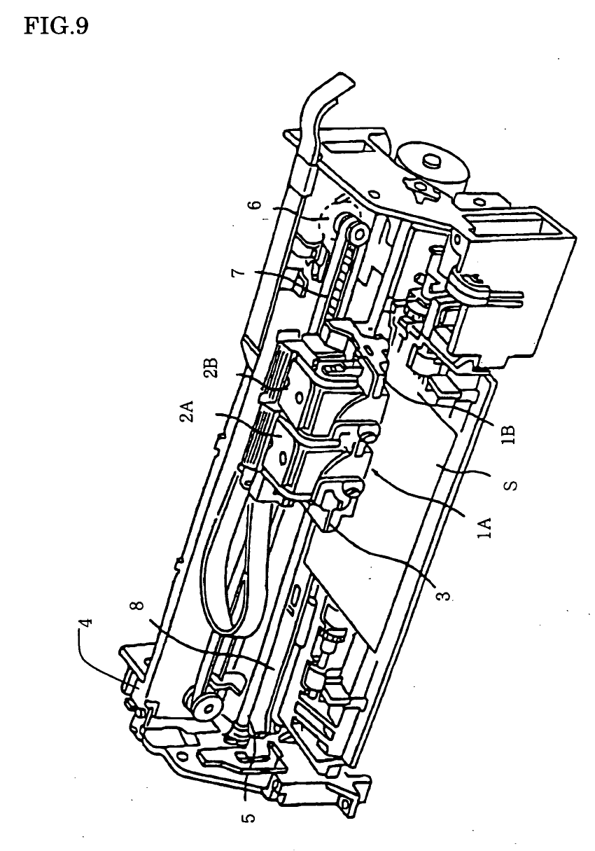

The ink jet recording head produced by the above-described manufacturing method is then mounted on an ink-jet recording apparatus as a part of a recording head unit having ink passages communicating with an ink cartridge, etc. FIG. 9 is a schematic view showing an example of this ink-jet recording apparatus. As shown in FIG. 9, cartridges 2A and 2B constituting ink supply means are detachably provided in recording head units 1A and 1B having the ink-jet recording heads, and a carriage 3 bearing the recording head units 1A and 1B is provided axially movably on a carriage shaft 5 mounted on an apparatus body 4. The recording head units 1A and 1B are to eject, for example, a black ink composition and a color ink composition, respectively. The drive force of a drive motor 6 is transmitted to the carriage 3 via a plurality of gears (not shown) and a timing belt 7, whereby the carriage 3 bearing the recording head units 1A and 1B is moved along the carriage shaft 5. The apparatus body 4 is provided with a platen 8 along the carriage shaft 5, and a recording sheet S as a recording medium, such as paper, which has been fed by a sheet feed roller or the like (not shown) is transported on the platen 8.

### Other Embodiments

Although the embodiments of the present invention have been described above, the present invention is not limited to these embodiments. In the above-described embodiments, the ink-jet recording head is taken for illustration as an example of the liquid-jet head which has the actuator device as a liquid ejection means and which is installed in a liquid-jet apparatus. However, the present invention widely targets actuator devices in general. Thus, needless to say, the present invention can be applied to liquid-jet heads for jetting liquids other than ink. Other liquid-jet heads include, for example, various recording heads for use in image recording devices such as printers, color material jet heads for use in the production of color filters such as liquid crystal displays, electrode material jet heads for use in the formation of electrodes for organic EL displays and FED (face emitting displays), and bio-organic material jet heads for use in the production of biochips. Furthermore, the present invention can be applied not only to actuator devices to be installed in liquid-jet heads, but also to actuator devices for installation in all types of apparatuses. Other apparatuses having actuator devices installed therein are, for example, sensors in addition to the above-mentioned liquid-jet heads. It should be understood that such changes, substitutions and alterations can be made therein without departing from the spirit and scope of the invention as defined by the appended claims.

What is claimed is:

1. A method for producing an actuator device, comprising the steps of:
forming a vibration plate on one surface of a substrate; and
forming piezoelectric elements, each of which composes a lower electrode, a piezoelectric layer, and an upper electrode, on the vibration plate, and
wherein the step of forming the vibration plate has an insulation film formation step including at least a film forming step of forming a zirconium layer on the one surface of the substrate, and a thermal oxidation step of thermally oxidizing the zirconium layer at a predetermined thermal oxidation temperature to form an insulation film comprising a zirconium oxide layer and, simultaneously, adjusting a stress of the insulation film.

2. The method for producing an actuator device according to claim 1, wherein in the thermal oxidation step, the stress of the insulation film is adjusted by controlling the thermal oxidation temperature.

3. The method for producing an actuator device according to claim 1, wherein in the thermal oxidation step, the zirconium layer is thermally oxidized by a diffusion furnace.

4. The method for producing an actuator device according to claim 1, wherein the temperature during thermal oxidation of the zirconium layer is 800° C. or above, but 1,000° C. or below.

5. The method for producing an actuator device according to claim 1, wherein the insulation film formation step further includes an annealing step which is performed after the thermal oxidation step to anneal the insulation film at a temperature not higher than the thermal oxidation temperature, thereby adjusting the stress of the insulation film further.

6. An actuator device produced by the method of claim 1.

7. A liquid-jet apparatus comprising a liquid-jet head having the actuator device of claim 6 as a liquid ejection means.
